(19) United States
(12) Patent Application Publication
(10) Pub. No.: US 2025/0307314 A1
(43) Pub. Date: Oct. 2, 2025

(54) UNIFIED XML INDEXING

(71) Applicant: Oracle International Corporation, Redwood Shores, CA (US)

(72) Inventors: Madhupriya Ravishankar, Sunnyvale, CA (US); Rodrigo Fuentes Hernandez, Redwood CIty, CA (US); Zhen Hua Liu, San Mateo, CA (US); Harichandan Roy, Amarillo, TX (US); Roger Andrew Ford, Twickenham (GB); Qin Yu, Belmont, CA (US); Aleksandra Czarlinska, Sunnyvale, CA (US); Bo Xia, Sunnyvale, CA (US)

(21) Appl. No.: 18/812,520

(22) Filed: Aug. 22, 2024

Related U.S. Application Data
(60) Provisional application No. 63/573,231, filed on Apr. 2, 2024.

(51) Int. Cl. G06F 16/832; G06F 16/838; G06F 16/84

(52) U.S. Cl. CPC G06F 16/832; G06F 16/86

(57) ABSTRACT

Techniques are described for unified indexing of semi-structured data. In an embodiment, a database management system (DBMS) stores a number of semi-structured data documents in its tables. Such documents include section(s) of nodes arranged in a hierarchy, having a root node and one or more leaf nodes. DBMS may receive a query specifying a path expression for the documents. Based on the path expression, the DBMS generates a query path identifier. The query path identifier is used as a lookup into the index store to determine that the query path identifier is a section path identifier for a partial hierarchical path. If so, the DBMS retrieves from the identified document at least one result node by evaluating nodes hierarchically belonging to the particular root node according to the query.

### RELATED APPLICATIONS

This application claims the benefit under 35 U.S.C. § 119(e) of provisional application 63/573,231, filed Apr. 2, 2024, by Ravishankar et al., the entire contents of which is hereby incorporated by reference. This application is also related to U.S. Pat. No. 8,694,510, entitled “Indexing Xml Documents Efficiently,” filed on May 18, 2004, referred to herein “Indexing Patent,” the entire contents of which are incorporated by reference as if fully set forth herein; and U.S. Pat. No. 11,481,439, entitled “Evaluating XML Full Text Search,” filed on Dec. 21, 2020, referred to herein “Full Text Search Patent,” the entire contents of which are incorporated by reference as if fully set forth herein.

### FIELD OF THE TECHNOLOGY

The present invention relates to the field of electronic database management, in particular to unified semi-structured data indexing.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Semi-structured data such as extensible Markup Language (XML) XML and JavaScript Object Notation (JSON) offer several advantages over fully structured data or unstructured data. Semi-structured data allows for flexible and dynamic schemas. Unlike traditional structured databases, where the schema must be defined before data insertion, semi-structured data formats like JSON or XML allow for schema evolution over time.

Furthermore, semi-structured data is well-suited for handling large volumes of data and diverse data types. It can accommodate data from heterogeneous sources without requiring strict schema enforcement.

When such diverse data is aggregated into semi-structured data, efficient querying of data becomes challenging. One type of data may be more efficiently accessible when queried using patterns, another when queried using hierarchical paths, yet another type of data may be speedier accessed using fully qualified queries.

For that reason, perhaps one of the key advantages of semi-structured data is that it can be queried in multiple ways. For example, semi-structured data can be queried using schema-based queries, keyword searches, and pattern matching. This flexibility in querying makes it suitable for diverse use cases ranging from simple data retrieval to complex analytics and data mining tasks.

When semi-structured data is stored on a database management system (DBMS), it is advantageous to additionally take advantage of the DBMS capabilities for indexing and therefore, making data access even faster. However, the challenge is that DBMS indexing is designed to accelerate the querying of fully structured data.

To alleviate this problem, DBMS may employ various indexing on the same semi-structured data to ensure that the semi-structured data maintains its flexibility in querying and furthermore, utilize the capabilities of DBMS for even faster querying.

Accordingly, a DBMS indexes the same semi-structured data many times to provide the capability for access for different types of querying. For example, for a DBMS to fully index semi-structured data, the DBMS may need to perform both a full-text scan and a scalar value-based scan. The DMBS may additionally perform other scans that may be particular to the substance of the data. Performing multiple scans on the same data is computing resource intensive, especially when the scans have to be repeated when the data has been updated. Accordingly, maintaining different indexes for different purposes is both cumbersome and resource intensive.

Additionally, when the indexes are generated for the semi-structured data, traversing the index itself when a group of nodes is requested is also resource-intensive. For example, when a DBMS receives a query on semi-structured data that specifies filtering-based condition(s) on values in the specified query path(s) (value/value range predicate), then one approach is to traverse the path-based indexes and then scan the corresponding row values from the column store of the database to select the row values matching the criteria. Another approach would be to traverse the value index and then scan the corresponding path from the table store to determine whether the query path matches. Both approaches are wasteful as they both involve scanning column stores and retrieving row values that may not match the query.

### BRIEF DESCRIPTION OF THE DRAWINGS

In the drawings of certain embodiments in which like reference numerals refer to corresponding parts throughout the figures:

FIG. 1 illustrates an example system for evaluating a query on semi-structured data;

FIG. 2A is a block diagram depicting a database table storing XML documents, in an embodiment;

FIG. 2B is a hierarchical diagram 201 depicting the above XML documents excerpt as an information hierarchy, in an embodiment;

FIG. 3 is a block diagram that depicts the process for indexing semi-structured data stored on a DBMS, in an embodiment;

FIG. 4 is a block diagram that depicts a sectional index store table and the process of converting the full paths and node names (e.g., leaf path node names) to the corresponding path identifiers and node identifiers, in an embodiment;

FIG. 5 is a block diagram that depicts the leaf node value indexing table and the process of converting the full paths to the corresponding path identifiers, in an embodiment.

FIGS. 6A and 6B are block diagrams that depict document bitmaps for “ns:salary” node values, in an embodiment.

FIG. 7A is a block diagram that depicts updated indexing and mapping tables after a new document is inserted, in an embodiment;

FIG. 7B is a block diagram that depicts updated indexing and mapping tables after a document is deleted, in an embodiment;

FIG. 7C is a block diagram that depicts updated indexing and mapping tables after a document is updated, in an embodiment;

FIG. 8A is a block diagram that depicts the process of query processing for semi-structured data using index data structures described herein, in an embodiment;

FIG. 8B is a block diagram that depicts the process of query-time generation of bitmap indexes, in an embodiment;

FIGS. 9A and 9B are block diagrams that depict example bitmaps obtained in response to query predicates, in one or more embodiments;

FIG. 10 is a block diagram of a basic software system, in one or more embodiments;

FIG. 11 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, structures and devices are shown in block diagram form in order to avoid unnecessarily obscuring the present invention.

### General Overview

The approaches herein describe single-scan indexing of semi-structured data that is stored in a database management system (DBMS) to generate several types of index data structures that are efficient for text and/or path-based range search queries of semi-structured data. The DBMS may maintain an indexing configuration for semi-structured data, which indicates which portion(s) of the semi-structured data to index and which portion(s) of the semi-structured data to omit from indexing. The criteria in such indexing configuration may be path-based, data type-based, node name, or node value-based as non-limiting examples.

The DBMS may perform indexing of semi-structured data stored by performing event-based scanning. Event-based scanning refers to parsing the stored semi-structured data to generate events for the indexing process, each event indicating detection of different components of the stored semi-structured data (e.g., a start element, an end element, an attribute, a textual portion.)

In an embodiment, the DBMS generates indices to (sub-) sections of semi-structured using the received events. The DBMS determines whether an element of semi-structured data is a root node for a section (a subtree of nodes). The DBMS generates a unique identifier for the path to the root node and stores the unique identifier in association with the reference to the location at which the root node of the sub-tree is stored in the DBMS. The location may be represented by a document identifier of the document and the sequence order number of the occurrence of the node.

For example, the DBMS may compute a full-path hash of each relevant full path from the root node. The full-paths that correspond to a particular leaf-path may be stored at the same location (e.g., bucket) for better query performance.

In an embodiment, the path includes the namespace of each node in the path. Accordingly, the unique identifier generated for a path is additionally based on the namespace information. Using these technique, the unique identifiers are guaranteed to be unique within a set of documents, even if documents have the same node names but for different namespaces. However, if the namespace information is not provided, the identifier generated for such path may still be unique and used as the unique identifier for the path in the techniques described herein.

Additionally or alternatively, the DBMS may index leaf node values. If the path is for a leaf node, the DBMS generates a unique identifier for the path to the leaf node and stores the unique path identifier in association with the leaf node's value in the index data store.

Furthermore, when a leaf node is detected, the DBMS may index the leaf node value itself. For each unique combination of node name and value, the location of such a node is encoded into the index using a bitmap. When the DBMS encounters another node having the same name and the same value (albeit a different path), the DBMS updates the bitmap to indicate the new node's location in the same bitmap. Thus, the DBMS indexing generates for a particular node name and particular node value, a location bitmap of every corresponding document in the database. In such a bitmap, each unique bit represents a unique location in the database. The bit-to-location mapping is maintained the same at least for every unique node name that is scanned. However, the bitmap to location mapping may be different among different node names.

For example, if multiple XML documents stored in the DBMS contain multiple <SALARY> (named) nodes having values 50K, 50K, 50K, 70K, 80K and 85K values, for the given set, the DBMS may generate three bitmaps, one per each unique node name/value pair. The bitmap for the 50K value includes three different bits that are set, each bit corresponding to a different document stored in the database at which the 50K value is stored.

A DBMS may use such location bitmaps to accelerate the result generation for queries that contain predicates on the bitmapped node values. For example, continuing with the <SALARY> node name above, a query may be received for <SALARY> node values that are less than the 75K value. The DBMS may obtain the bitmap for the 50K value and the bitmap for the 70K value from the index store and perform a bitwise OR to generate the result location bitmap. The result location bitmap contains all the locations in the database that satisfy the query's filtering clause.

### System Overview

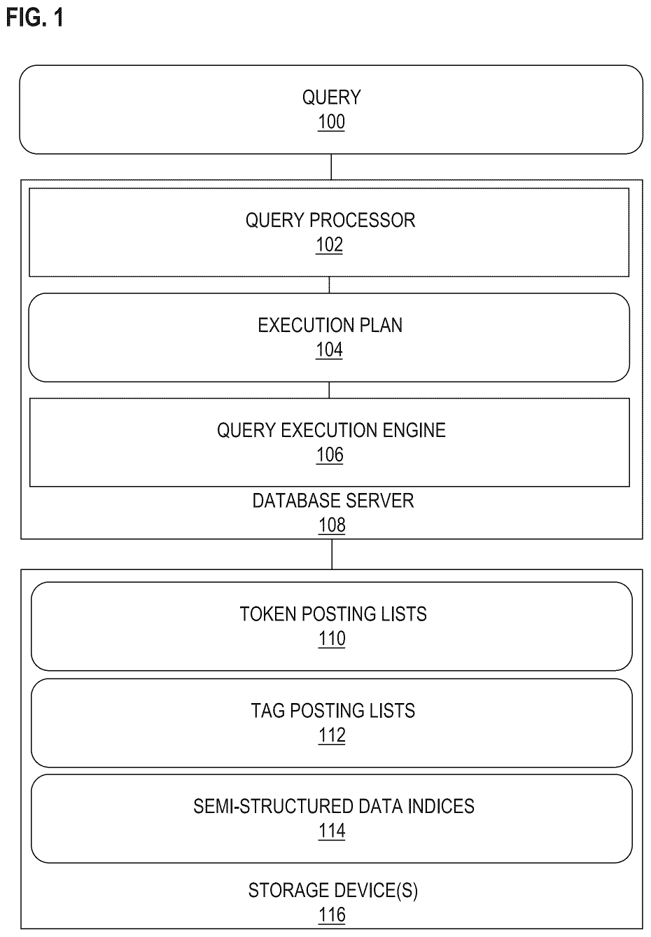

FIG. 1 illustrates an example system for evaluating a query on semi-structured data. As shown, a full-text query is received by a database server 108 at a query processor 102. Query processor 102 generates an execution plan 104 that instructs the query execution engine 106 on how to execute the query. For example, the execution plan may instruct query execution engine 106 to perform some operations before others or to use certain indices to perform certain portions of the query. Query processor 102 and/or query execution engine 106 may have access to storage device(s) 116, which may include an allocated portion of memory in database server 108, disk storage in an underlying database, or some other non-transitory storage. Query processor 102 may instruct query execution engine 106 to use token posting lists 110, tag posting lists 112, and semi-structured data indices 114 to compute results for query 100, as further described in Full-Text Search Patent and Indexing Patent.

### Semi-Structured Data Storage

In an implementation, the semi-structured data is stored in relational tables. Each document of the semi-structured data may be stored in a corresponding row of a table having a row identifier at least unique for the table.

For example, the following XML document may be stored in a row of a table in an XMLType column of the DBMS:

```
<ns:root>
  <ns:employee employeeID=“1001”>
    <ns:name>John Doe</ns:name>
    <ns:hiring_date>2023-05-15</ns:hiring_date>
    <ns:salary>50000</ns:salary>
  </ns:employee>
</ns:root>
```

Another row in the same table may store the following XML document, having multiple <employee> nodes.

```
<ns:root>
  <ns:employee employeeID=“1002”>
    <ns:name>Alice Smith</ns:name>
    <ns:hiring_date>2022-10-20</ns:hiring_date>
    <ns:salary>50000</ns:salary>
  </ns:employee>
  <ns:employee employeeID=“1003”>
    <ns:name>Michael Johnson</ns:name>
    <ns:hiring_date>2023-01-08</ns:hiring_date>
    <ns:salary>70000</ns:salary>
  </ns:employee>
  <ns:employee employeeID=“1004”>
    <ns:name>Sarah Williams</ns:name>
    <ns:hiring_date>2024-02-12</ns:hiring_date>
    <ns:salary>85000</ns:salary>
  </ns:employee>
</ns:root>
```

Although the example herein uses XML, JSON, or other semi-structured data with a hierarchical information structure may use the same techniques as described herein.

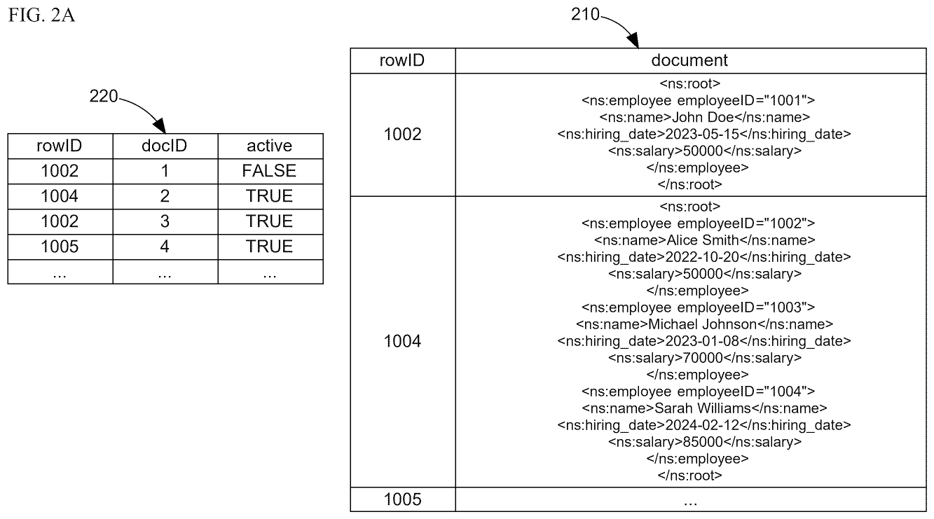

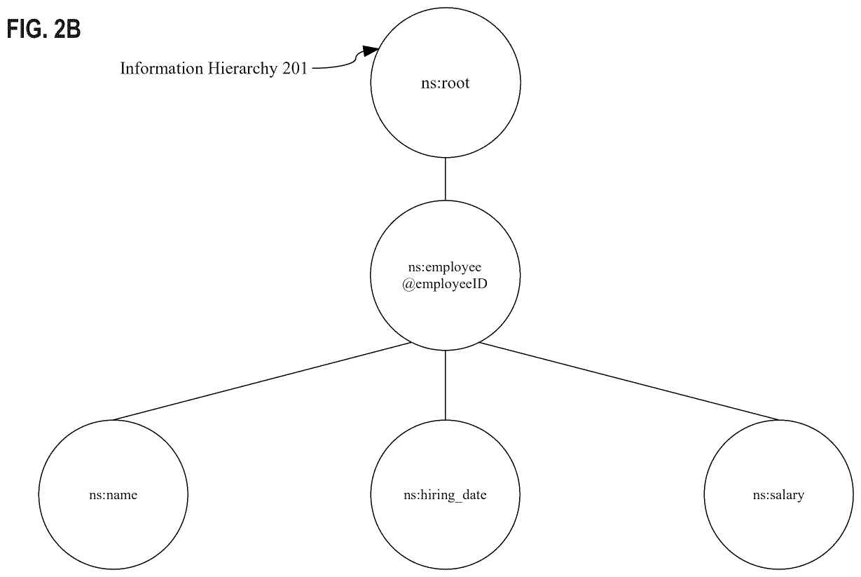

FIG. 2A is a block diagram depicting a database table storing XML documents, in an embodiment. Table 210 contains XML type “document” column for storing XML documents. Although, the example XML documents in Table 210 contain namespace identifier (e.g., “ns”), the same techniques apply to XML documents that may omit the namespace identifier. Each row stores a separate XML document and is identified by a row identifier in the “rowID” column.

In an embodiment, a DBMS may maintain an incrementing logical identifier that tracks each version of a semi-structured data document stored in a semi-structured table. Whenever a document is updated due to a DML operation or other operation, the row identifier of the document may not change. However, the document identifier will be incremented. The DBMS may maintain table 220, the document-to-row mapping table, that maps document identifiers to the corresponding row.

The document-to-row mapping table may have the same row mapped to different documents. For example, table 220 contains two rows that have the “rowID” value of 1002 mapping to the “documentID” value of 1 and 3. However, the mapping for the “documentID” value of 1 is marked as inactive in the “active” column, indicating that this mapping is invalid. Such indication may have been generated due to an update to the document stored at “rowID” 1002. For example, the document at “rowID” 1002 may have previously stored a node value of “75,000” for <ns:salary> node. Then, the DBMS may have received a DML operation that has updated the same document to a “50,000” value. As a result of the update, the “rowID” identifier has not changed. However, a new document identifier is generated, 3, and the existing row identifier is mapped to the new document identifier, while the previous mapping is invalidated. Table 220 depicts the invalidation by updating a column value that tracks the status of the mapping. However, other implementations may use other techniques, such as erasing the mapping. In such an implementation, if the mapping is not found then the mapping is no longer valid.

FIG. 2B is a hierarchical diagram 201 depicting the above XML documents excerpt as an information hierarchy, provided herein to facilitate an understanding of embodiments of the invention. Hierarchical diagram 201 depicts nodes that correspond to the same-named elements or element attributes of the sample XML document.

An information hierarchy may have different types of data items arranged in a hierarchy. For example, the sample XML document contains nodes and node attributes. For example, the “@employeeID” is an attribute of node “employee”, while the “ns:name”, “ns:hiring_date” and “ns:salary” nodes are descendant nodes of the “ns:employee” node. The edge between the nodes “ns:employee” and “ns:name” thus represents the parent-child relationship between node the nodes “ns:employee” and “ns:name”.

Nodes at the same level of an information hierarchy are referred to as sibling nodes. For example, the “ns:name”, “ns:hiring_date” and “ns_salary” are sibling nodes but are descendants of the “ns:employees” and “ns:employee” nodes. In an information hierarchy, the nodes and their respective attributes have values that are not depicted for compactness.

### Semi-Structured Data Indexing

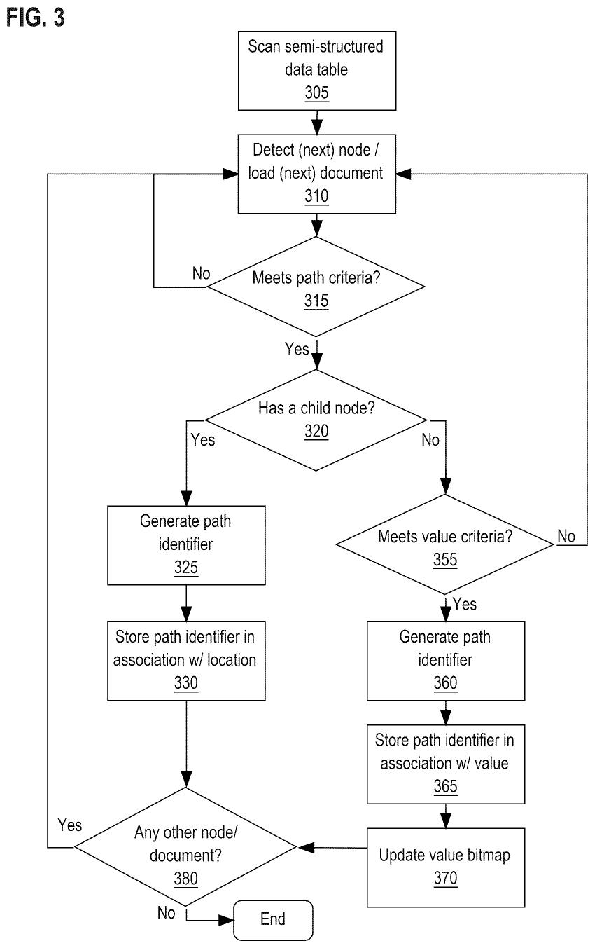

FIG. 3 is a block diagram that depicts the process for indexing semi-structured data stored on a DBMS, in an embodiment. At step 305, the indexing is initiated, and the table containing semi-structured data is scanned. The indexing may be initiated after the first time the table is detected or when a trigger condition for indexing is met. The trigger condition may include a particular number of new/updated rows in a table.

At step 305, the DBMS scans the table by reading rows of the table. For a new table, the DBMS may read each and every row. For a modified table, the DBMS may maintain row identifiers to the modified rows to be scanned and scan only those rows to save computing resources. The DBMS sequentially loads the document at each scanned row to scan the document itself for indexing.

### Indexing Configuration for Path Filtering

In an embodiment, the DBMS maintains configuration for indexing semi-structured data stored in the database. The configuration may be user-configurable and may include default configuration data. The configuration may be modified by receiving user input to modify the configuration data. This greatly reduces storage overhead by allowing the user to only enable indexing on the kind of queries that are foreseen to be most prevalent.

In an embodiment, the indexing configuration data indicates the path(s) for the node(s) that are to be excluded from indexing and/or, conversely, the path(s) of the node(s) that are only to be included indexing. When indexing, the current path of a node may be compared to the path in the configuration to determine whether the current path of the node qualifies for the path indexing criteria and, thus, may be indexed. If the current path fails to meet the path indexing criteria, then the current path is excluded, and the indexing process may proceed to the next node.

The configuration data for the path indexing criteria may be an expression. For example, for XML data, the path indexing criteria may be indicated in the XPATH format. The XPATH may indicate the paths to include or to exclude. Thus, if the current path qualifies for the exclusion XPATH of the indexing configuration data, then the current path is excluded, and otherwise, the current path is included. If the current path qualifies for the inclusion XPATH of the indexing configuration data, then the XML node at the current path is included and otherwise, the XML node is excluded from the indexing.

Continuing with FIG. 3 At step 310, the DBMS detects a new node while scanning the retrieved document. At step 315, the DBMS compares the path to the new node with the indexing configuration data to ascertain whether the path to the new node meets the path indexing criteria. If the indexing configuration data indicates exclusion paths and the path matches, then the node is excluded from indexing. Similarly, if the path fails to match the inclusion path(s) of the path index configuration data, then the path also fails the path indexing criteria. The process transitions to step 310 to detect the next node of the document or to scan the next document if no further nodes are detected in the current document.

Otherwise, if the path to the new node is not excluded by the path indexing criteria, as determined at step 315, the process proceeds to step 320 to generate section-based indexing and/or step 355 to generate the node value-based indexing data.

### Sectional Indexing

Continuing with FIG. 3, at step 320, the DBMS determines whether the current node has descendent nodes. If the current node has descendent nodes, then the current node is at the root of a sub-tree, and thus, sectional indexing to such node improves the search during query processing.

For example, when the process is traversing the nodes stored at “rowID” 1002 of Table 210 of FIG. 2A, node “ns:root” has descendent nodes such as node “ns:employee”. This is evident from Information Hierarchy 201 of FIG. 2B, where the “ns:root” node is a parent of “ns:employee” node, which itself is a parent of “ns:salary”, “ns:hiring_date”, and “ns:name” nodes.

Accordingly, at step 325, for section (sub-tree) root nodes, such as “ns:root” and “ns:employee”, unique identifier(s) are generated based on the path thereof. In an implementation, the DBMS may generate a unique identifier for the full path to the current node and/or a unique identifier for the current node name. Additionally, the path and/or the node name may include the namespace identifier to ensure that the node names are fully qualified and thus unambiguous. In these example nodes, the namespace identifier of “ns” is included to make the node names fully qualified. However, in other examples, the full definition of the namespace may be included instead. A semi-structured data document, such as an XML document, may include the full definition of the namespace such “xmlns:ns=“http://example.com/ns””.

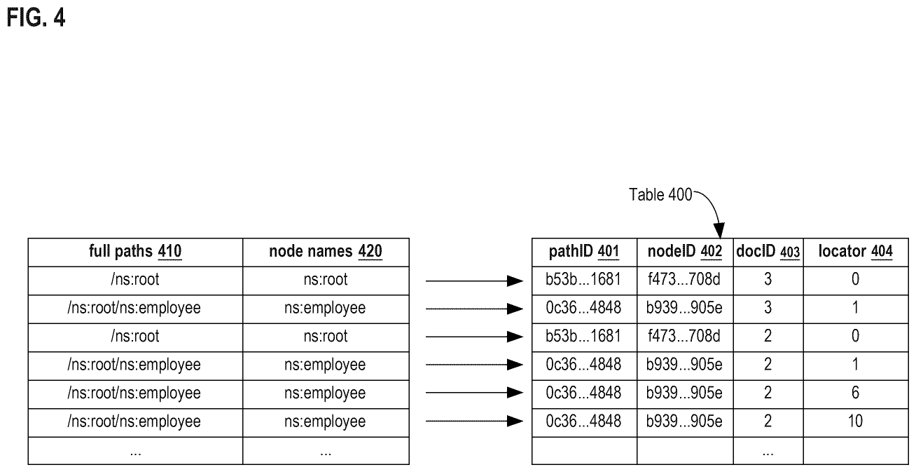

FIG. 4 is a block diagram that depicts the sectional index store table and the process of conversion of the full paths and node names to the corresponding path identifiers and node identifiers, in an embodiment. PathID 401 and nodeID 402 of sectional indexing table 400 include the generated unique identifiers of the corresponding full paths and node names of the detected sub-tree root nodes, respectively. The values of full paths 410 and node names 420 are hashed to generate corresponding pathID 401 and nodeID 402's column values of sectional indexing table 400.

Continuing with FIG. 3, at step 330, the DBMS stores the generated path identifier(s) of the current node in association with the information indicating the location of the current node. Since each semi-structured data document is stored in a separate row, the location may be indicated by the row identifier at which the document is stored. Additionally or alternatively, since each document may be tracked by a corresponding document identifier, the document identifier may be used.

In FIG. 4's sectional indexing table 400, for each detected sectional root node, the corresponding identifier(s) of the node is stored in association with the document identifier (docID) of the document of the root node. Additionally, the location of the root node in the document may be indicated by the value in locator 404. Such location may be the element order number of the detected node.

For example, the indexing process may have detected a sectional root node at “/ns:root/ns:employee” while scanning the XML document stored at the rowID of 1002 of FIG. 2 having the document identifier of 3 from mapping table 220. The detected sectional root node is the second detected node in the document and thereby has an element index value of 1 (in a zero-based index). The indexing process hashes the full path of the node (as depicted in the second row of full paths 410 of FIG. 4) and may additionally hash the node name (as depicted in the second row of node names 420 of FIG. 4). The resulting hashes are stored in the second row of sectional indexing table 400 in association with the document identifier of value 3 in docID column 403 and the element index value of 1 for locator column 404.

Accordingly, when, for example, a query is received for “//ns:employee” or “/ns:root/ns:employee”, indexing sectional table 400 has the exact location of the node satisfying the query. Because multiple documents may have the same path and/or the same named sectional root nodes, multiple entries in indexing table 400 may satisfy the query.

Continuing with the above query example, indexing table 400 may return 4 entries having docID and locator pair values of {3, 1}, {2, 1}, {2, 6}, and {2, 10}, indicating the documents and nodes that satisfy the query.

In an implementation, the indexing table 400 may serve as a tag posting list, or a tag posting list may be generated from indexing table 400. Indexing table 400 maps the tag/node names of the nodes to the documents and, more so, to the location within the documents. Such mapping is the information included in a tag posting list. Techniques for using posting lists are described in the Full Text Search Patent.

### Indexing Configuration for Leaf Node Value Indexing

In an embodiment, when a leaf node is detected, the node value of the node is indexed based on the node path. Continuing with FIG. 3, the process may detect a new node at step 310, which meets the path indexing criteria at step 315. At step 320, the process determines whether the node has any child node or is a leaf node (has no child node).

If it is determined, at step 320, that the node is a leaf node, the process transitions to step 355, to index the node value of the leaf node based on the node's path.

For example, when the process is traversing the nodes stored at “rowID” 1002 of Table 210 of FIG. 2A, nodes “ns:salary”, “ns:hiring_date”, and “ns:name” have no child node and thus, are determined to be leaf nodes.

In an embodiment, the indexing configuration data indicates the nodes to exclude based on the node values of such nodes. When indexing, the node value of the detected node may be compared to the value(s) or an expression of values in the configuration to determine whether the detected node qualifies for the node value indexing criteria and, thus, may be indexed. If the current node has a value that fails to meet the node value indexing criteria, then the current node is excluded, and the indexing process may proceed to the next detected node.

In one embodiment, the configuration data for the node value indexing criteria specifies the data type(s) of node values to include or exclude. Even if the semi-structured data fails to specify the data type of the node value, the indexing process may ascertain the data type of a node value. For example, the node value indexing criteria may indicate the exclusion of node values with datetime data type. A sample XML node may contain a text value of a node which may or may not conform to date time string standard. The indexing process may call a special function (e.g., a data type cast or isDateTime( ) function) to determine whether the node string value conforms to the DateTime data type. Similar steps may be performed for integer values, which may be stored in the semi-structured data as text. Additionally, the data type may be specified by a type cast in the query of the semi-structured data.

In another embodiment, the configuration data for the node value indexing criteria specifies a regular expression (regex) to include or exclude nodes whose value(s) match the regex. If the node value indexing criteria specify to exclude nodes with node values matching the specified regex, then such nodes are excluded from indexing. The nodes with non-matching node values are included in the indexing. Conversely, if the node value indexing criteria specifies to include only the node values matching the specified regex, then such nodes are included in the indexing. The nodes with non-matching node values are excluded from the indexing in such an example.

The techniques may include other types of node value indexing criteria, such as one based on having a particular value (e.g., NULL) or value range.

Continuing with FIG. 3, at step 355, the DBMS selects the value of the leaf node and evaluates the value against the node value indexing criteria. If the node value meets the criteria, the process proceeds to step 360. Otherwise, the process proceeds to step 310 to detect a new node or load a new document, if any.

### Leaf Node Value Indexing

At step 360, for leaf nodes such as “ns:name”, “ns:hiring_date” and “ns:salary” unique identifier(s) are generated based on the path thereof. In an implementation, the DBMS may generate a unique identifier for the full path to the current leaf node and just for the leaf node, separately. Additionally, the path may include the namespace identifier to ensure that the path is fully qualified. In these example nodes, the namespace identifier of “ns” is included to make the path fully qualified. In other examples, the full definition of the namespace may be included instead. A semi-structured data document, such as an XML document, may include the full definition of the namespace such “xmlns:ns=“http://example.com/ns””.

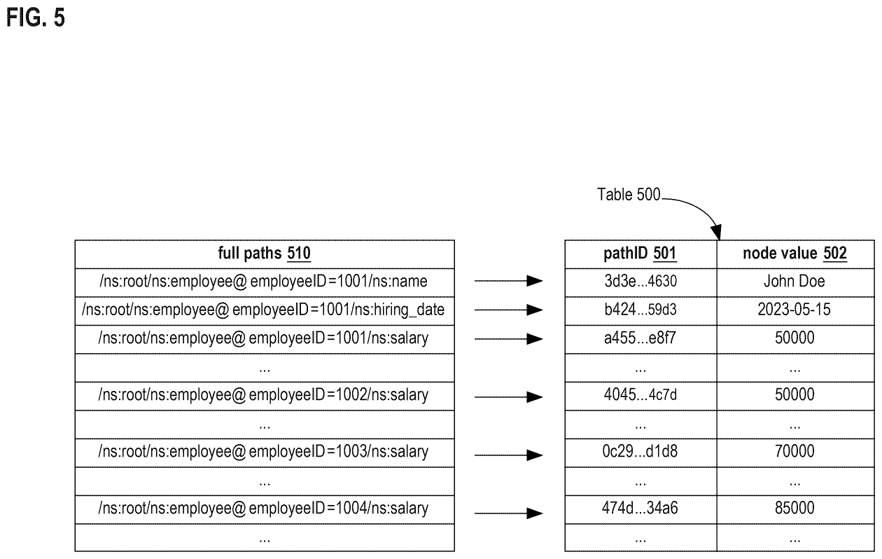

FIG. 5 is a block diagram that depicts leaf node value indexing table and the process of converting the full paths to the corresponding path identifiers, in an embodiment. The paths in pathID 501 of leaf node value indexing table 500 include the generated unique identifiers of the corresponding full paths. In this example, the values of full paths 510 are hashed to generate corresponding unique identifiers in pathID 501 of leaf node indexing table 400.

Continuing with FIG. 3, at step 365, the DBMS stores the generated path identifier(s) of the detected leaf node in association with the node value of the leaf node. In FIG. 5's node value indexing table 500, for each detected leaf node, the corresponding full path identifier of the leaf node is stored in association with the node value of the respective leaf node.

### Document Bitmap for Node Value

The DBMS may maintain tag and token posting lists of nodes and node values as described in the Full Text Search Patent.

Additionally or alternatively, the documents that contain structured data sections (SDATA) may also be indexed into posting list(s). For example, after an unstructured paragraph, the document may contain a “tag” for “pagenumber”: <pagenumber>1</pagenumber>. Such values may be used to filter document results. For that reason, SDATA section indexing speeds up the filtering process and makes it more compute resource efficient.

In an embodiment, SDATA sections are indexed into posting lists. The posting lists may use a delta encoding for the document identifier(s) and/or the document location offset(s). SDATA index may maintain a minimum value in the posting list as “VAL_MIN” and a maximum value in the posting list as “VAL_MAX metadata.

An example posting list may have the following information:

```
Delta_docid_1
  Length of delta-encoded offset list
  Delta_Offset_1
  Length_of_SDATA_value_1
  SDATA_value_1
  Delta_Offset_2
  Length_of_SDATA_value_2
  SDATA_value_2
  ...
  Delta_Offset_N
  Length_of_SDATA_value_N
  SDATA_value_N
Delta_docid_2
...
Delta_docid_N
```

In an embodiment, such posting lists are stored in a set of tables known as searchable SDATA tables (indicated as “$S*”), where the table name may indicate the data type of values being stored. For example, the suffix may correspond to a letter of a set of letters to identify the data type being stored, such as $SN for numbers or $ST for timestamps.

In addition to the DBMS maintaining token posting lists of node values as described above and in the Full Text Search Patent, the DBMS may maintain a bitmap of document identifiers indicating the location of a particular node value. Each such bitmap, therefore, may be associated with a particular leaf node name or leaf node path having a particular node value.

For example, the DBMS may maintain a set of bitmaps, each respective bitmap associated with each unique value of the leaf nodes that have node name “<ns:salary>.” Stated differently, each unique value of “<ns:salary>” node has a bitmap indicating its location.

In an embodiment, each bit in such a bitmap represents whether a particular semi-structured data document contains the associated node value for the associated leaf node name. For example, bit one may represent the document with a document identifier of 1, while bit two may represent the document with a document identifier of 2. If a particular bit in a bitmap is set, then the corresponding document contains a leaf node with the associated node name, having the node value associated with the bitmap, in an embodiment.

Continuing with FIG. 3, at step 370, when the process is scanning a detected leaf node value, the process determines whether a bitmap exists for the leaf node value. If not, the process generates a bitmap for the node value of the leaf node name. The process updates the existing or newly generated bitmaps to set the bit that corresponds to the document being scanned by the process. At step 380, the process repeats until all the documents and nodes have not been traversed.

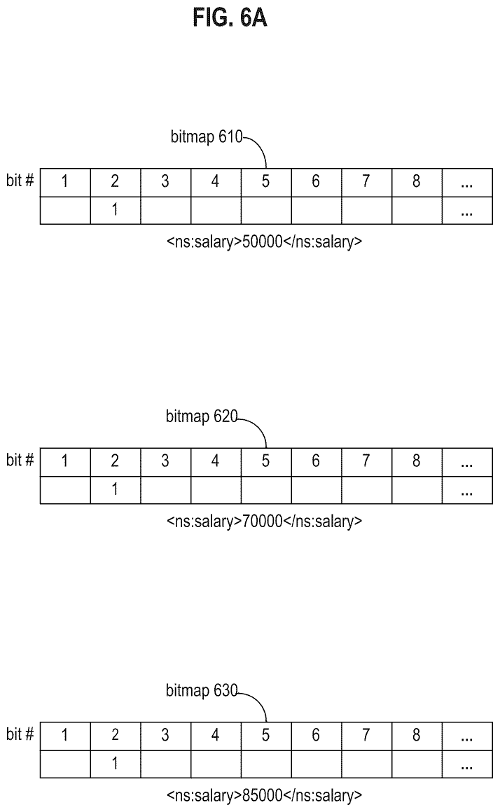

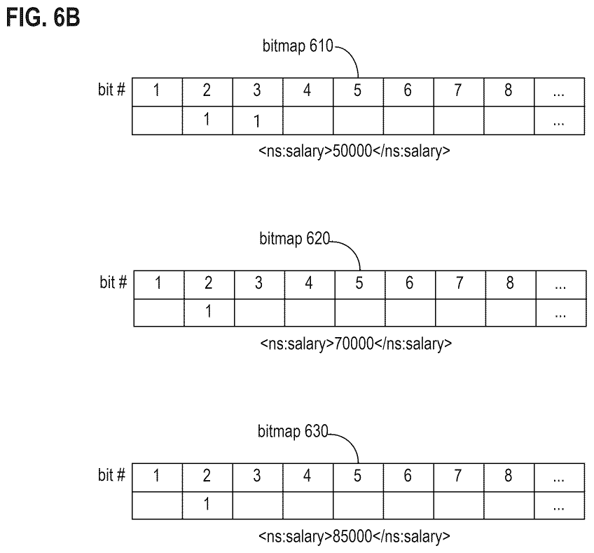

FIGS. 6A and 6B are block diagrams that depict document bitmaps for “ns:salary” node values, in an embodiment. Continuing with the example documents of FIG. 2A, when “ns:salary” node is detected for the first time in the document with docID 2 stored at rowID 1004 of Table 210, the DBMS generates bitmap 610 for the node value 50000 of “ns:salary”. In bitmap 610, the first bit corresponds to the document with docID equal to 1, while the second bit of bitmap 610 corresponds to the document with docID 2, and so forth. Accordingly, bitmap 610 is generated for the node value of “<ns:salary>50000</ns:salary>” with bit number 2 set to 1, thereby indicating that the document with docID 2 contains such a node value.

When the indexing process detects the next “ns:salary” node in the document (docID 2), the node value for “ns:salary” is different. For that reason, the indexing process generates another bitmap, bitmap 620, for the “<ns:salary>70000</ns:salary>” node value. Again, bitmap 620 has the second bit set to indicate that the document with docID 2 contains this node value. Similarly, bitmap 630 is generated for “<ns:salary>85000</ns:salary>.”

The indexing process then scans the next document with docID 3 stored at rowID 1002 as depicted in FIG. 2A. When the indexing process detects “ns:salary” node having value 50000, the indexing process determines that a bitmap exists for this node name/value, bitmap 610. As depicted in FIG. 6B, the indexing process updates the bit number 3 corresponding to docID 3 to indicate that the document with docID 3 also contains the “<ns:salary>50000</ns:salary>” node value.

In an embodiment, by generating bitmaps 610-630, the DBMS may more efficiently and faster evaluate value range predicates of semi-structured data queries. For example, the queries for a range of salaries may be evaluated by aggregating the corresponding bitmaps into the resulting bitmap that indicates all the documents where the document contains node values in the predicate range.

The indices described herein may be generated and maintained by the DBMS synchronously and asynchronously to the received queries that use the indices. In some embodiments, one or more of the indices may be created and updated using an explicit query received from a user, i.e. manually.

### Maintaining Index Consistency Through Modifications of Documents

In an embodiment in which the indices are asynchronous to the query received or are cached, DMLs and other operations may invalidate the indices when the operations modify existing semi-structured data documents or create new documents. Such changes may affect the consistency and accuracy of the DBMS-maintained indices. Accordingly, the DBMS has to consistently update the index stores to ensure that the indices are consistent and will not return outdated data.

When a new document is inserted into a table as a new row, the DBMS generates a new document identifier, a new document identifier (docID), for the new document. The DBMS inserts a new mapping into the document-to-row mapping table that associates the new docID to the rowID into which the new document was inserted. The indexing of the document uses the new docID.

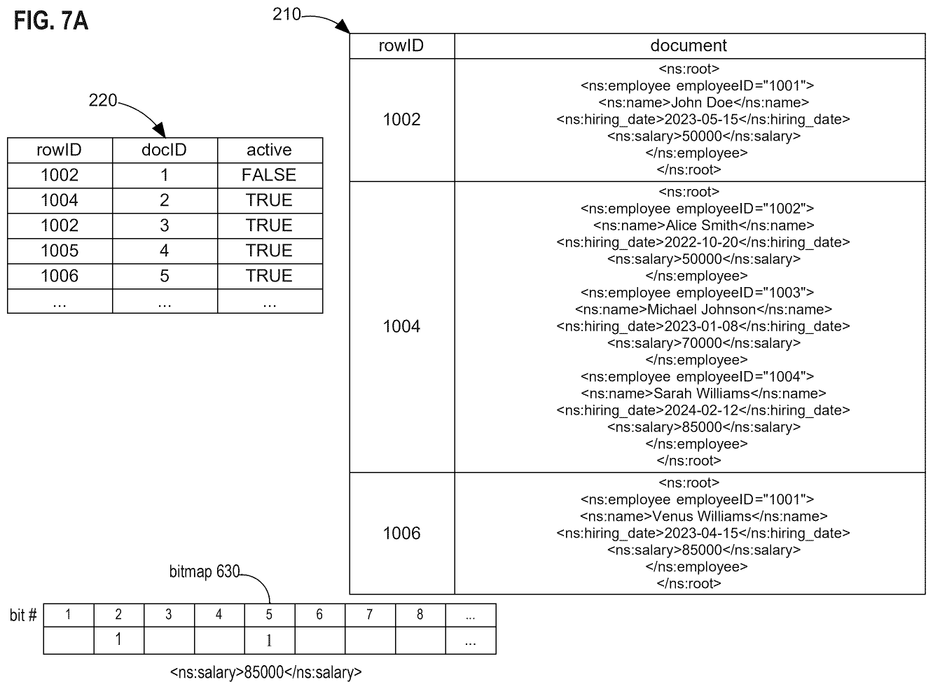

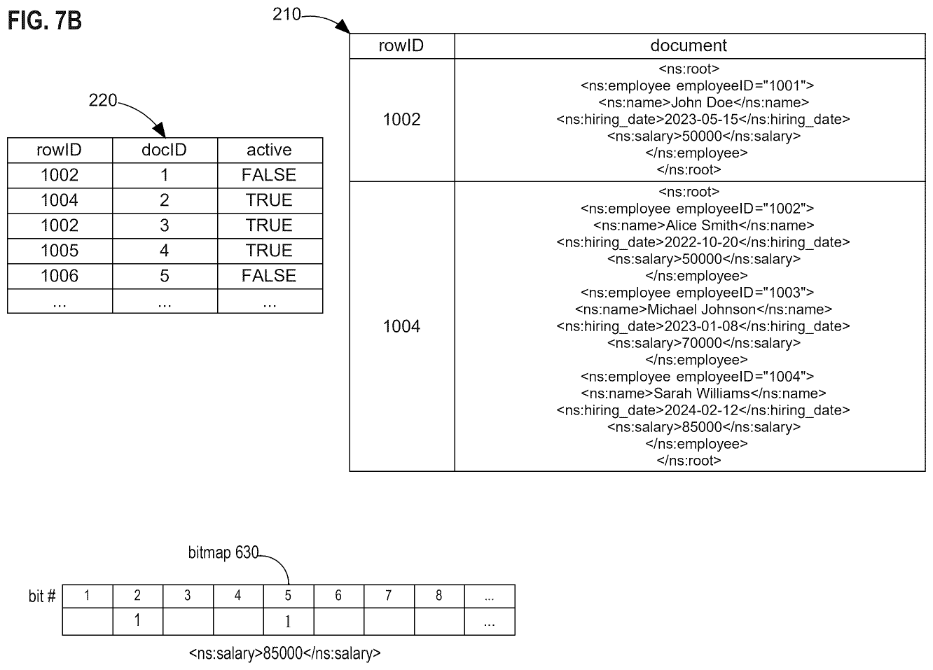

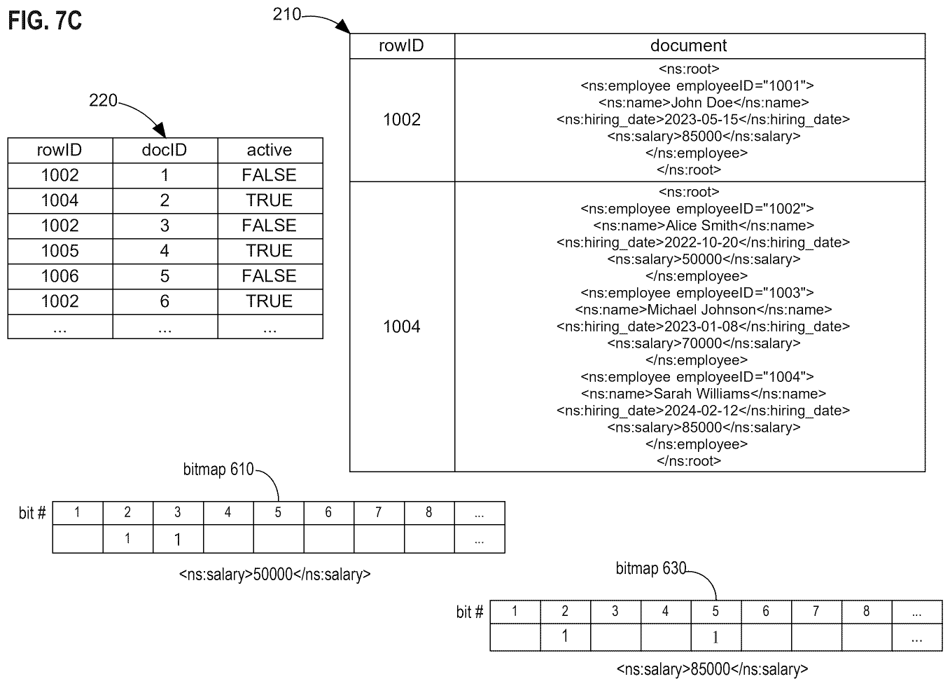

For example, FIG. 7A is a block diagram that depicts updated indexing and mapping tables after a new document is inserted, in an embodiment. A received DML inserts a new XML document into table 210 at rowID 1006. The new document contains “<ns:salary>85000</ns:salary>” leaf node value. At the time of insert, the DBMS generates a new docID 5 and adds new mapping into mapping table 220, associating the newly inserted rowID 1006 with docID 5. Accordingly, when the new document is indexed, bitmap 630 for “<ns:salary>85000</ns:salary>” is updated with setting bit #5 to indicate that the document with docID 5 contains the “<ns:salary>85000</ns:salary>” node value.

On the other hand, when an existing document is deleted, the DBMS may delete the row in which the document is stored. The DBMS may also delete or deactivate the row in the document-to-row mapping table that corresponds to the deleted document's docID. The indexing data structures have no need to change because the docID to rowID mapping is severed. Accordingly, the delete operation on an existing document may not trigger the costly operation of re-indexing.

For example, FIG. 7B is a block diagram that depicts updated indexing and mapping tables after an existing document is deleted, in an embodiment. A received DML deletes the XML document at rowID 1006 from table 210. The document contained “<ns:salary>85000</ns:salary>” leaf node value. The DBMS updates the mapping of rowID 1006 to docID 5 to be deactivated. Although bitmap 630 still contains a set bit for bit #5, the no longer existing document, the docID to rowID mapping is deactivated for docID 5. Thus, when the DBMS attempts to retrieve the reference based on bitmap 630, no rowID will be returned.

When an existing document is updated, the DBMS may update the document information in the same row in which the document is stored. However, since the document has changed, the DBMS may generate a new document identifier, new docID, for the updated document. The DBMS maps the new docID to the existing row while also deleting or deactivating the row in the document-to-row mapping table that corresponds to the document's previous docID. The indexing data structures may not change because the docID to rowID mapping is severed. Accordingly, the update operation on an existing document may not trigger the costly operation of re-indexing.

For example, FIG. 7C is a block diagram that depicts updated indexing and mapping tables after a document is updated, in an embodiment. A received DML updates XML document at rowID 1002 in table 210 to change “<ns:salary>50000</ns:salary>” to “<ns:salary>85000</ns:salary>”. The DBMS generates a new document identifier for the updated document, docID 6 and inserts a new row into document-to-row mapping table 220 to map docID 6 to rowID 1002, at which the update was performed.

The DBMS also deactivates the previous mapping of rowID 1002 to docID 3 because the previous version of the document stored at rowID 1002 no longer exists and has been updated with a new version. Although bitmap 610 still contains a set bit for bit #3 (indicating the previous version of the document), the docID to rowID mapping is deactivated for docID 3. Thus, when the DBMS attempts to retrieve the reference based on bit #3 of bitmap 630, no rowID is returned. However, after indexing the new version of the document, bitmap 630, for newly updated node value “<ns:salary>85000</ns:salary>” has bit #5 set to indicate the updated document with docID 5 having this node value.

### Query Processing

By treating each unique path as a separate section, the techniques described herein may skip performing post-filter range-search querying of results during the query time, thereby saving processing time previously spent on determining whether the scalar value is present on a given path in the document.

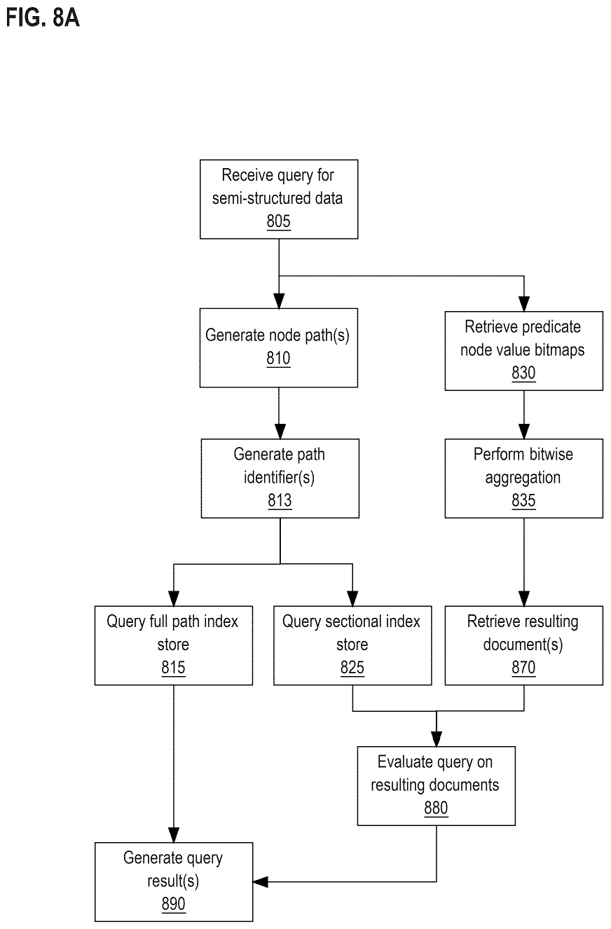

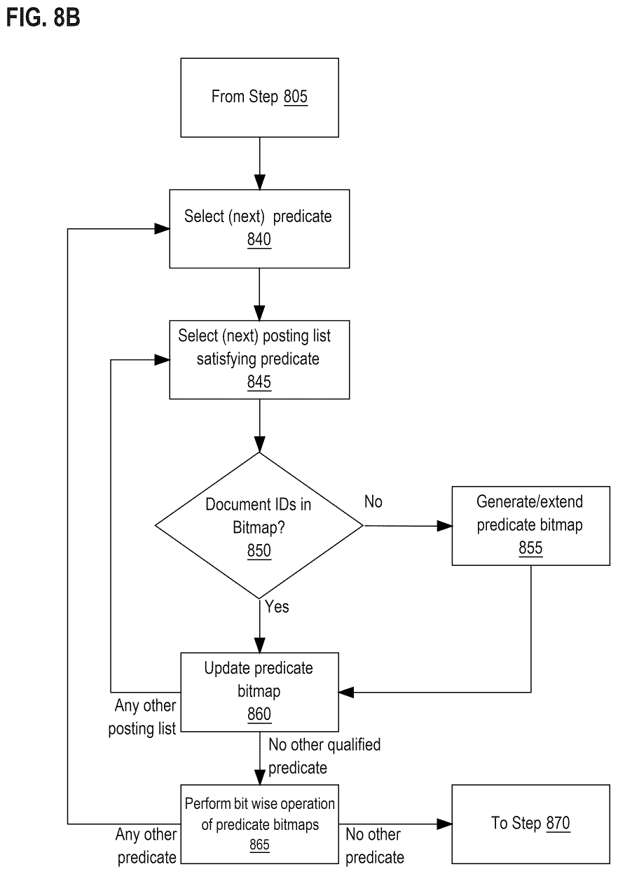

FIG. 8A is a block diagram that depicts the process of query processing for semi-structured data using indexing data structures described herein, in an embodiment. At step 805, DBMS receives a query targeting semi-structured data stored in a database. Non-limiting examples of such a query may be an XQFT query or an Xquery, as described in Full Text Query Patent and Indexing Patent. Such a query may contain path expression(s) directed specifically to semi-structured data, such as XPATH. At step 810, the query path expression(s) are converted into node paths that include the namespace of the node names. The techniques for generating node paths from the query expressions are described in Indexing Patent.

At step 813, a generated node path is converted into a corresponding path identifier, using, as an example, a hash function to generate the corresponding path hash.

In an embodiment, the DBMS may use a generated path identifier to query both leaf node value indexing table, at step 815, and the sectional indexing table, at 825, to determine whether the path identifier is for a leaf node value or a root node of sectional data. If, at step 815, the querying of the leaf node value indexing table is successful, and a node value is returned, then the path identifier is for a leaf node value. The process may proceed to step 890 to generate the result for the query based on the returned node value from the leaf node value indexing table.

At step 825, the sectional index table may also be queried using the same generated path identifier. If an entry is returned, then the path identifier is for a root node of sectional data. The result may indicate the document(s) and the location of the sectional root node that matched the path identifier. At step 880, the query is evaluated by traversal of the returned sectional root node(s). The process proceeds to step 890 to generate the results for the query.

The received query at step 805 may include a predicate for node values. For example, the query may contain “[number(ns:salary)>=50000 and number(ns:salary)<=100000].” At step 830, the DBMS may query the bitmaps in the index store to determine whether document bitmap(s) exist for the node name(s) referenced in the query.

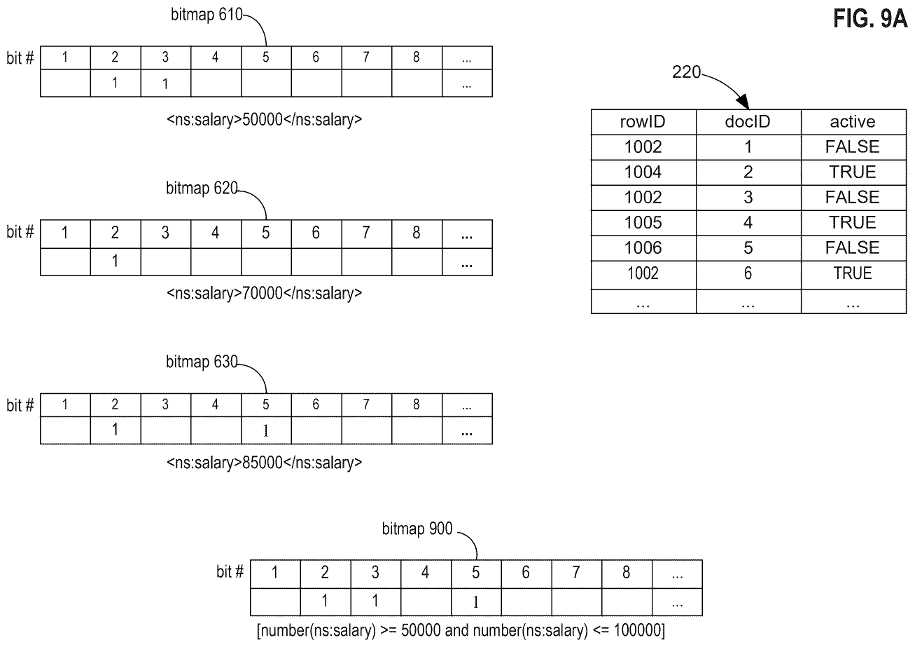

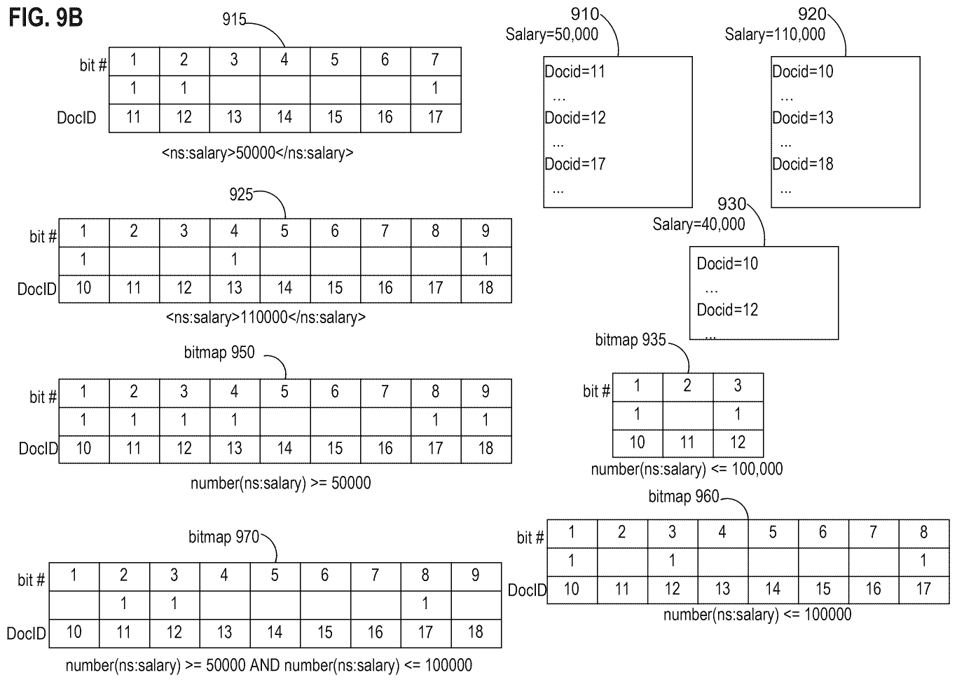

FIG. 9 is a block diagram that depicts the example bitmaps that are retrieved in response to a query predicate, in an embodiment. Bitmap 610 corresponds to <ns:salary> node value of 50000 and, therefore, is selected. Similarly, Bimap 620 and Bitmap 630 have corresponding associated node values that meet the query predicate (70000 and 85000) and are selected by the process for that reason.

Continuing with FIG. 8A, at step 835, the process performs an aggregation of bitmaps to generate a resulting bitmap that is representative of the query predicate. If the predicate is a range, the process performs bitwise OR of the bitmaps, whose associated node values meet the query predicate condition to yield the resulting bitmap. If the query predicate is an “AND” condition, then the selected bitmaps are bitwise-ANDed together to yield the resulting bitmap.

Continuing with the example of FIG. 9, bitmaps 610, 620 and 630 are bitwise-Ored together to be representative of the query range predicate, generating resulting bitmap 900. The resulting bitmap is used to retrieve the documents that meet the query predicate.

Continuing with FIG. 8A, at step 870, the process retrieves all the documents indicated by the resulting bitmap. At step 880, the DBMS evaluates the query on the retrieved document(s) and generates the result for the query at step 890.

### Query-Time Document Bitmap Generation

Additionally or alternatively, the query received at step 805 may specify an SDATA operator, and thereby, the DBMS may utilize SDATA posting lists to process the query. For example, the SDATA operator may have the following arguments: SDATA(section_name <relational_operator> <literal_value>) where “relational_operator” is one of “<”, “<=”, “>=”, “>”, “=” predicates, and “literal_value” is a value of the same data-type as the one registered for the SDATA section before indexing.

In an embodiment, for a path-aware range search, users may not register the SDATA section with the index. Instead, such sections are automatically detected and indexed, using techniques discussed above, into full-path identifiers and leaf-path identifiers.

Because the DBMS maintains full-path and leaf-path indices using techniques described herein, the DBMS has no need to perform a leaf-path search with the same node name and perform an expensive offset-join back for node values (path-tokens) stored in the inverted index table.

To leverage full-path identifier for determining a range of values in the document as fast as possible (e.g., for predicate evaluations that indicate ranges such “<” or “>”), a posting list is maintained for each unique value (no embedded SDATA values) for same leaf-path nodes, in an embodiment. Accordingly, only a single metadata column may be used (e.g., “VAL_MIN”, discarding “VAL_MAX” or vice versa) because the posting lists correspond to a single value. An example posting list may contain:

```
Delta_docid_1
  Delta_offset_1
  Delta_offset_2
  ...
  Delta_offset_N
Delta_docid_2
...
Delta_docid_N
```

which is similar to the posting list format used by the inverted index table.

Accordingly, the queries over specific paths no longer need to join on the offsets, thereby, increasing the query performance. However, the query is still susceptible to degradation through index fragmentation, which is also often found with posting lists used by inverted indexes.

In an embodiment, the posting list(s) (stored on disk) are transformed into an in-memory bitmap during query execution. FIG. 8B is a block diagram that depicts a process of transforming a set of posting lists into a bitmap for a received query, in an embodiment. The predicate(s) for the query received at step 805 of FIG. 8A are determined. At step 840, the DBMS iterates through each predicate. The process matches the predicate of the query to posting list(s) based on the leaf-node name and value-range indicated in the predicate of the query. Accordingly, at step 845, the DBMS selects the posting list(s) for which the associated node value satisfies the selected query predicate. Such posting list(s) include document identifier(s) of document(s) that should satisfy the query's predicate selected at step 840.

During the first iteration for the selected predicate, at step 850, no bitmap for the predicate may have yet been generated and no document identifier has yet been identified. Accordingly, the process proceeds to step 855 to generate the bitmap of document identifiers for the predicate based on the first qualified posting list. As discussed above, the bitmap represents the document identifiers of the documents that satisfy at least one predicate of the query. The DBMS generates the initial bitmap in which each bit represents a unique document identifier in the range of document identifiers present in the selected first posting list. At step 860, each document identifier that is included in the posting list has its corresponding bit set in the bitmap, and the document identifiers that are in the range of document identifiers of the bitmap but are not referenced in the posting list have their corresponding bit unset.

For the next posting list, at step 850, the process determines whether the bitmap has to be extended to represent additional document identifiers. The new posting list may contain document identifiers that do not have any bit assigned in the current bitmap. At step 855, the process extends the bitmap to include new bits for representing the new document identifier(s) that did not have any bit of the original bitmap assigned.

In one implementation, the bitmap arranges the bits to correspond to a continuous range of document identifiers. For example, the first bit represents the lowest value of the document identifiers, the last bit represents the highest value of the document identifier, while the bits in between represent the document identifier between the lowest and highest value of the document identifiers.

In such an implementation, if the newly selecting posting list contains document identifier(s) that are not between the highest and the lowest document identifiers (are not within the range of the document identifiers), then the process proceeds to step 855. At step 855, the process extends the current bitmap to expand the document identifier range to include all the document identifiers in the new posting list. At step 860, the extended bitmap is updated according to the existing bitmap and the document identifiers identified in the new posting list. Accordingly, the bitmap updated at step 860 represents all the document identifiers that were referenced in the new posting list and the previous posting list(s) that satisfied the selected predicate.

The process performs steps 845-860 for each posting list that qualifies for the selected query predicate. If no other posting list qualifies for the predicate, the process transitions to step 865. At step 865, the bitwise operation is performed between the bitmaps for the current predicate and the previously selected predicate(s) of the received query. The bitwise operation corresponds to the type of aggregation of the processed predicates in the query is performed (e.g., for “AND” aggregate a bitwise AND is performed and for “OR” aggregate a bitwise OR is performed). If the document identifiers of the bitmaps are not aligned, the bitmap(s) are extended (shifted) to align such that each bit corresponds to the same document identifier in the predicate bitmaps.

The steps 840-865 are performed for each predicate in the received query. If no other predicate exists in the query, the process proceeds to step 870 of FIG. 8A to evaluate the query on the resulting bitmap indicating the qualified documents.

FIG. 9B is a block diagram that depicts bitmaps generated from posting lists satisfying a predicate of a query, in an embodiment. Continuing with the example query that contains the following predicates “[number(ns:salary)>=50000 and number(ns:salary)<=100000],” the DBMS may first evaluate “number(ns:salary)>=50000” and generate the resulting bitmap. Then, the process generates the next predicate bitmap for “number(ns:salary)<=100000” and performs a bitwise AND operation.

For the predicate “number(ns:salary)>=50000”, posting lists 910 and 920 both qualify as they correspond to the “salary” node name values 50000 and 70000, respectively, while posting list 930 does not because the “salary” node name value is 40000. The DBMS may first evaluate posting list 910, and discover that the range of document identifiers contained in posting list 910 is from document identifier 11-17. The DBMS may generate corresponding bitmap 915, in which the first bit corresponds to document identifier 11 and the last bit to document identifier 17. Similarly, for next posting list 920, the DBMS may generate bitmap 925 for the document identifier range from 10 to 18. To generate the result for predicate that includes both, bitmaps 920 and 925 are to be bitwise OR-ed. To make the bitmaps have the same arrangement of bits for the bitwise operation, the new range of document identifiers that includes both bitmap 915 and 925 is determined. That new range is from document identifier 10 to 18 and each of bitmaps 915 and 925 are extended to the same range by shifting and/or otherwise extending the bitmap. Bitmap 950 is the result of bitwise OR operation of bitmaps 915 and 925 and represents the documents that qualify for the “number(ns:salary)>=50000” predicate.

Similarly, bitmaps 935 is generated for the “number(ns:salary)<=100000” predicate, in which posting list 930 of value 40,000 and 910 of 50,000 qualifies, while posting list 920 does not qualify. Before the bitwise OR operation, bitmap 915 of posting list 910 is extended to include document identifier 10 and bimap 935 is extended to include document identifies 13-17 (not depicted in FIG. 9B). The extended bitmaps are bitwise ORed to generate bitmap 960 that represents the documents that qualify for the “number(ns:salary)<=100000” predicate.

Since the two predicates have AND aggregate operation (“[number(ns:salary)>=50000 and number(ns:salary)<=100000]”), bitmap 950 is bitwise ANDed with bitmap 960 to generate bitmap 970. Bitmap 960 may be extended by one bit to include document identifier 18 that is present in bitmap 950 before the bitwise AND operation (not depicted in FIG. 9B). Bitmap 970 represents the documents by their corresponding document identifiers that qualify for the query predicates (“[number(ns:salary)>=50000 and number(ns:salary)<=100000]”). The query may then be evaluated by retrieving the documents with the document identifiers indicated by the set bit(s) of the resulting bitmap. The resulting and intermediate bitmaps may include metadata that indicates the first and/or the last bit's document identifier and/or the lengths of the bitmap.

In an embodiment, the bitmap structure and its metadata may be deallocated after the query execution or may be cached or permanently stored for the repeat usage, as described herein.

### Database Management System Overview

A database management system (DBMS) manages a database. A DBMS may comprise one or more database servers. A database comprises database data and a database dictionary that are stored on a persistent memory mechanism, such as a set of hard disks. Database data may be organized into database objects and stored in one or more data containers. Each container contains records. The data within each record is organized into one or more fields. In relational DBMSs, the data containers are referred to as tables, the records are referred to as rows, and the fields are referred to as columns. In object-oriented databases, the data containers are referred to as object classes, the records are referred to as objects, and the fields are referred to as attributes. Other database architectures may use other terminology to refer to database objects.

In embodiments, the databases may be structured as key-value stores (e.g., NoSQL or JSON) where different database objects may represent different data structures. Key-values and associated objects can be referenced, for example, utilizing lookup tables such as hash tables.

Users interact with a database server of a DBMS by submitting to the database server commands that cause the database server to perform operations on data stored in a database. A user may be one or more applications running on a client computer that interact with a database server. Multiple users may also be referred to herein collectively as a user.

As used herein, “query” refers to a database command and may be in the form of a database statement that conforms to a database language. In one embodiment, a database language for expressing the query is the Structured Query Language (SQL). There are many different versions of SQL, some versions are standard and some proprietary, and there are a variety of extensions. Data definition language (“DDL”) commands are issued to a database server to create or configure database schema, including database containers, such as tables, views, or complex data types. SQL/XML is a common extension of SQL used when manipulating XML data in an object-relational database. Although the embodiments of the invention are described herein using the term “SQL,” the invention is not limited to just this particular database query language and may be used in conjunction with other database query languages and constructs.

A client may issue a series of requests, such as requests for execution of queries, to a database server by establishing a database session, referred to herein as “session.” A session comprises a particular connection established for a client to a database server, such as a database instance, through which the client may issue a series of requests. The database server may maintain session state data about the session. The session state data reflects the current state of the session and may contain the identity of the user for which the session is established, services used by the user, instances of object types, language and character set data, statistics about resource usage for the session, temporary variable values generated by processes executing software within the session, and storage for cursors and variables and other information. The session state data may also contain execution plan parameters configured for the session.

Database services are associated with sessions maintained by a DBMS with clients. Services can be defined in a data dictionary using data definition language (DDL) statements. A client request to establish a session may specify a service. Such a request is referred to herein as a request for the service. Services may also be assigned in other ways, for example, based on user authentication with a DBMS. The DBMS directs requests for a service to a database server that has been assigned to running that service. The one or more computing nodes hosting the database server are referred to as running or hosting the service. A service is assigned, at run-time, to a node in order to have the node host the service. A service may also be associated with service-level agreements, which are used to assign a number of nodes to services and allocate resources within nodes for those services. A DBMS may migrate or move a service from one database server to another database server that may run on a different one or more computing nodes. The DBMS may do so by assigning the service to be run on the other database server. The DBMS may also redirect requests for the service to the other database server after the assignment. In an embodiment, after successfully migrating the service to the other database server, the DBMS may halt the service running in the original database server.

A multi-node database management system is made up of interconnected nodes that share access to the same database. Typically, the nodes are interconnected via a network and share access, in varying degrees, to shared storage, e.g., shared access to a set of disk drives and data blocks stored thereon. The nodes in a multi-node database system may be in the form of a group of computers (e.g., workstations, personal computers) that are interconnected via a network. Alternately, the nodes may be the nodes of a grid, which is composed of nodes in the form of server blades interconnected with other server blades on a rack.

Each node in a multi-node database system hosts a database server. A server, such as a database server, is a combination of integrated software components and an allocation of computational resources, such as memory, a node, and processes on the node for executing the integrated software components on a processor, the combination of the software and computational resources being dedicated to performing a particular function on behalf of one or more clients.

Resources from multiple nodes in a multi-node database system may be allocated to running a particular database server's software. Each combination of the software and allocation of resources from a node is a server that is referred to herein as a “server instance” or “instance.” A database server may comprise multiple database instances, some or all of which are running on separate computers, including separate server blades.

### Software Overview

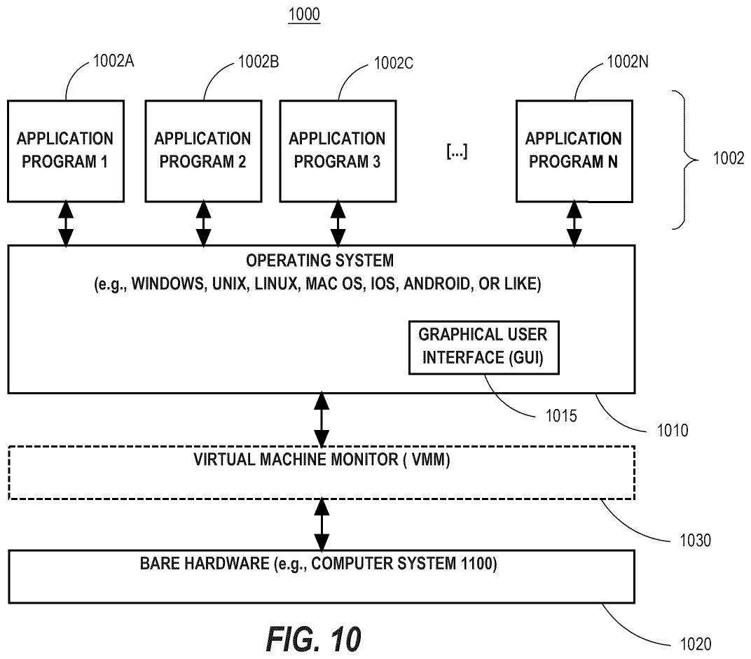

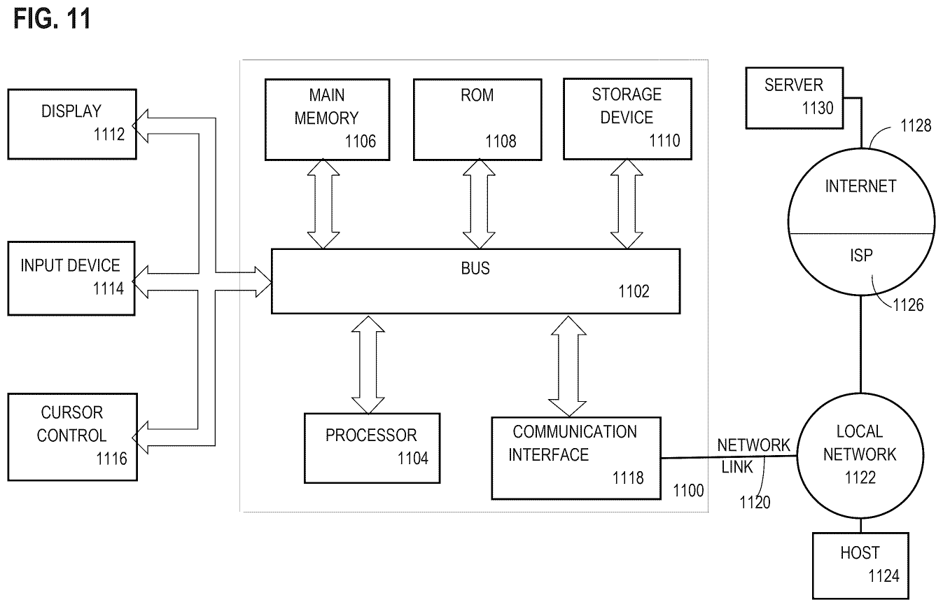

FIG. 10 is a block diagram of a basic software system 1000 that may be employed for controlling the operation of computing system 1100 of FIG. 11. Software system 1000 and its components, including their connections, relationships, and functions, are meant to be exemplary only, and not meant to limit implementations of the example embodiment(s). Other software systems suitable for implementing the example embodiment(s) may have different components, including components with different connections, relationships, and functions.

Software system 1000 is provided for directing the operation of computing system 1100. Software system 1000, which may be stored in system memory (RAM) 1106 and on fixed storage (e.g., hard disk or flash memory) 1110, includes a kernel or operating system (OS) 1010.

The OS 1010 manages low-level aspects of computer operation, including managing execution of processes, memory allocation, file input and output (I/O), and device I/O. One or more application programs represented as 1002A, 1002B, 1002C . . . 1002N, may be “loaded” (e.g., transferred from fixed storage 1110 into memory 1106) for execution by the system 1000. The applications or other software intended for use on computer system 1100 may also be stored as a set of downloadable computer-executable instructions, for example, for downloading and installation from an Internet location (e.g., a Web server, an app store, or another online service).

Software system 1000 includes a graphical user interface (GUI) 1015, for receiving user commands and data in a graphical (e.g., “point-and-click” or “touch gesture”) fashion. These inputs, in turn, may be acted upon by the system 1000 in accordance with instructions from operating system 1010 and/or application(s) 1002. The GUI 1015 also serves to display the results of operation from the OS 1010 and application(s) 1002, whereupon the user may supply additional inputs or terminate the session (e.g., log off).

OS 1010 can execute directly on the bare hardware 1020 (e.g., processor(s) 1104) of computer system 1100. Alternatively, a hypervisor or virtual machine monitor (VMM) 1030 may be interposed between the bare hardware 1020 and the OS 1010. In this configuration, VMM 1030 acts as a software “cushion” or virtualization layer between the OS 1010 and the bare hardware 1020 of the computer system 1100.

VMM 1030 instantiates and runs one or more virtual machine instances (“guest machines”). Each guest machine comprises a “guest” operating system, such as OS 1010, and one or more applications, such as application(s) 1002, designed to execute on the guest operating system. The VMM 1030 presents the guest operating systems with a virtual operating platform and manages the execution of the guest operating systems.

In some instances, the VMM 1030 may allow a guest operating system to run as if it is running on the bare hardware 1020 of computer system 1100 directly. In these instances, the same version of the guest operating system configured to execute on the bare hardware 1020 directly may also execute on VMM 1030 without modification or reconfiguration. In other words, VMM 1030 may provide full hardware and CPU virtualization to a guest operating system in some instances.

In other instances, a guest operating system may be specially designed or configured to execute on VMM 1030 for efficiency. In these instances, the guest operating system is “aware” that it executes on a virtual machine monitor. In other words, VMM 1030 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system and may run under the control of other programs being executed on the computer system.

Multiple threads may run within a process. Each thread also comprises an allotment of hardware processing time but share access to the memory allotted to the process. The memory is used to store the content of processors between the allotments when the thread is not running. The term thread may also be used to refer to a computer system process in multiple threads that are not running.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by or within a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers. In a cloud computing environment, there is no insight into the application or the application data. For a disconnection-requiring planned operation, with techniques discussed herein, it is possible to release and then to later rebalance sessions with no disruption to applications.

The above-described basic computer hardware and software and cloud computing environment presented for the purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field-programmable gate arrays (FPGAs) that are persistently programmed to perform the techniques, or may include one or more general-purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 11 is a block diagram that illustrates a computer system 1100 upon which an embodiment of the invention may be implemented. Computer system 1100 includes a bus 1102 or other communication mechanism for communicating information, and a hardware processor 1104 coupled with bus 1102 for processing information. Hardware processor 1104 may be, for example, a general-purpose microprocessor.

Computer system 1100 also includes a main memory 1106, such as a random access memory (RAM) or another dynamic storage device, coupled to bus 1102 for storing information and instructions to be executed by processor 1104. Main memory 1106 also may be used for storing temporary variables or other intermediate information during execution of instructions to be executed by processor 1104. Such instructions, when stored in non-transitory storage media accessible to processor 1104, render computer system 1100 into a special-purpose machine that is customized to perform the operations specified in the instructions.

Computer system 1100 further includes a read-only memory (ROM) 1108 or other static storage device coupled to bus 1102 for storing static information and instructions for processor 1104. A storage device 1110, such as a magnetic disk or optical disk, is provided and coupled to bus 1102 for storing information and instructions.

Computer system 1100 may be coupled via bus 1102 to a display 1112, such as a cathode ray tube (CRT), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

Computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor 1104 executing one or more sequences of one or more instructions contained in main memory 1106. Such instructions may be read into main memory 1106 from another storage medium, such as storage device 1110. Execution of the sequences of instructions contained in main memory 1106 causes processor 1104 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1110. Volatile media includes dynamic memory, such as main memory 1106. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that comprise bus 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or solid-state drive of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal, and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic, or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126, in turn, provides data communication services through the world wide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are example forms of transmission media.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110 or other non-volatile storage for later execution.

### Computing Nodes and Clusters

A computing node is a combination of one or more hardware processors that each share access to a byte-addressable memory. Each hardware processor is electronically coupled to registers on the same chip of the hardware processor and is capable of executing an instruction that references a memory address in the addressable memory, and that causes the hardware processor to load data at that memory address into any of the registers. In addition, a hardware processor may have access to its separate exclusive memory that is not accessible to other processors. The one or more hardware processors may be running under the control of the same operating system

A hardware processor may comprise multiple core processors on the same chip, each core processor (“core”) being capable of separately executing a machine code instruction within the same clock cycles as another of the multiple cores. Each core processor may be electronically coupled to connect to a scratchpad memory that cannot be accessed by any other core processor of the multiple core processors.

A cluster comprises computing nodes that each communicate with each other via a network. Each node in a cluster may be coupled to a network card or a network-integrated circuit on the same board of the computing node. Network communication between any two nodes occurs via the network card or network integrated circuit on one of the nodes and a network card or network integrated circuit of another of the nodes. The network may be configured to support remote direct memory access.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
storing a plurality of documents in a plurality of rows in one or more tables of a database management system (DBMS);
wherein each document of the plurality of documents includes one or more sections of nodes arranged in a hierarchy, having a root node and one or more leaf nodes;
receiving a first query, the first query specifying a path expression for the plurality of documents;
generating at least one query path based at least in part on the path expression, the at least one query path including a namespace indicator;
generating a query path identifier, based, at least in part, on the at least one query path;
based, at least in part, on looking up the query path identifier in an index store, determining that the query path identifier is a section-path identifier for a partial hierarchical path and retrieving, from a particular document of the plurality of documents, a particular root node corresponding to the section-path identifier in the index store;
retrieving at least one result node by evaluating nodes hierarchically belonging to the particular root node according to the first query.

2. The method of claim 1, further comprising:
receiving a second query, the second query specifying a full hierarchical path for the plurality of documents;
generating a full-path hash, based, at least in part, on the full hierarchical path;
retrieving a node value, based, at least in part, on a lookup of the full-path hash into the index store.

3. The method of claim 1, further comprising:
based, at least in part, on looking up the section-path identifier in the index store, obtaining at least one document identifier of at least one document of the plurality of documents;
based, at least in part, on doc-to-row mapping store, obtaining one or more row identifiers corresponding to the at least one document identifier, the one or more row identifiers identifying one or more result rows in the DBMS in which the at least one result node is stored;
retrieving the at least one result node, based at least in part the one or more row identifiers.

4. The method of claim 1, further comprising:
receiving a request to update the particular document and thereby generate a new updated document;
without re-indexing the plurality of documents to generate a new index store, deactivating mapping of the particular document in doc-to-row mapping store that maps the plurality of documents to the plurality of rows in the one or more tables of the DBMS.

5. The method of claim 4, further comprising:
in response to receiving the request to update the particular document:
inserting the new updated document in a new row of the one or more tables of the DBMS having a new row identifier, and
generating a new document identifier corresponding to the new updated document;
updating the doc-to-row mapping store to add a new row indicating association of the new document identifier with the new row identifier for the new updated document.

6. The method of claim 4, wherein the request is a DML statement to modify the particular document.

7. The method of claim 1, further comprising:
storing, in the index store, value-to-doc mapping comprising of plurality of bitmaps, wherein, for a unique node value, a corresponding bitmap is stored, each bit in the bitmap, of the plurality of bitmaps, representing a unique document of the plurality of documents in which the unique node value is present;
evaluating the first query, the first query comprising a filtering criteria on node values;
determining a result set of node values that match the filtering criteria and selecting a result set of bitmaps corresponding to the result set of node values;
performing a bitwise operation corresponding to the filtering criteria on the result set of bitmaps, thereby, generating a resulting bitmap;
evaluating the first query using resulting one or more documents of the plurality of documents corresponding to one or more bits of the resulting bitmap.

8. The method of claim 7, wherein the filtering criteria on the node values is a value range, and the method further comprising performing a bitwise OR operation on the result set of bitmaps, thereby, generating the resulting bitmap.

9. The method of claim 1, further comprising:
scanning the plurality of rows in the one or more tables of the DBMS;
identifying a first section root node of a first section of nodes of the one or more sections of nodes, wherein the first section root node is associated with a first section path;
identifying one or more first leaf nodes of the first section root node, corresponding to one or more first leaf paths;
indexing, into the index store, the first section path to the first section root node and the one or more first leaf paths to corresponding one or more leaf node values.

10. The method of claim 9, further comprising:
generating a first section hash value for the first section of nodes by generating a hash value of the first section path;
storing the first section hash value in the index store in association with a row identifier corresponding to a row at which the first section root node is stored in the DBMS;
generating one or more first leaf hash values corresponding to the one or more first leaf paths of the one or more first leaf nodes;
storing each of the one or more first leaf hash values in the index store in association with each respective node value of the one or more first leaf nodes.

11. The method of claim 1, further comprising:
scanning the plurality of rows in the one or more tables of the DBMS;
identifying a second section root node of a second section of nodes of the one or more sections of nodes, wherein the second section root node is associated with a second section path;
based at least in part on index configuration data, determining whether the second section path a) is included in an exclusion index list of paths, or b) is not included in an inclusion index list of paths;
based, at least in part, on determining whether the second section path a) is included in an exclusion index list of paths, or b) is not included in an inclusion index list of paths, exclude the second section root node and hierarchy of the second section root node from indexing.

12. The method claim 11, further comprising:
scanning the plurality of rows in the one or more tables of the DBMS;
identifying one or more second leaf nodes of the second section root node, corresponding to one or more second leaf paths;
based at least in part on the index configuration data, determining whether the second section each of the one or more second leaf paths a) is included in an exclusion index list of paths, b) is not included in an inclusion index list of paths, c) or has a node value of excluded data type;
based, at least in part, on determining whether the second section each of the one or more second leaf paths a) is included in an exclusion index list of paths, b) is not included in an inclusion index list of paths, c) or has a node value of excluded data type, exclude the said each of the one or more second leaf paths from indexing.

13. One or more non-transitory computer-readable media storing a set of instructions, wherein the set of instructions includes instructions, which when executed by one or more hardware processors, cause:
storing a plurality of documents in a plurality of rows in one or more tables of a database management system (DBMS);
wherein each document of the plurality of documents includes one or more sections of nodes arranged in a hierarchy, having a root node and one or more leaf nodes;
receiving a first query, the first query specifying a path expression for the plurality of documents;
generating at least one query path based at least in part on the path expression, the at least one query path including a namespace indicator;
generating a query path identifier, based, at least in part, on the at least one query path;
based, at least in part, on looking up the query path identifier in an index store, determining that the query path identifier is a section-path identifier for a partial hierarchical path and retrieving, from a particular document of the plurality of documents, a particular root node corresponding to the section-path identifier in the index store;
retrieving at least one result node by evaluating nodes hierarchically belonging to the particular root node according to the first query.

14. The one or more non-transitory computer-readable media of claim 13, wherein the set of instructions further includes instructions, which when executed by said one or more hardware processors, cause:
receiving a second query, the second query specifying a full hierarchical path for the plurality of documents;
generating a full-path hash, based, at least in part, on the full hierarchical path;
retrieving a node value, based, at least in part, on a lookup of the full-path hash into the index store.

15. The one or more non-transitory computer-readable media of claim 13, wherein the set of instructions further includes instructions, which when executed by said one or more hardware processors, cause:
based, at least in part, on looking up the section-path identifier in the index store, obtaining at least one document identifier of at least one document of the plurality of documents;
based, at least in part, on doc-to-row mapping store, obtaining one or more row identifiers corresponding to the at least one document identifier, the one or more row identifiers identifying one or more result rows in the DBMS in which the at least one result node is stored;
retrieving the at least one result node, based at least in part the one or more row identifiers.

16. The one or more non-transitory computer-readable media of claim 13, wherein the set of instructions further includes instructions, which when executed by said one or more hardware processors, cause:
receiving a request to update the particular document and thereby generate a new updated document;
without re-indexing the plurality of documents to generate a new index store, deactivating mapping of the particular document in doc-to-row mapping store that maps the plurality of documents to the plurality of rows in the one or more tables of the DBMS.

17. The one or more non-transitory computer-readable media of claim 16, wherein the set of instructions further includes instructions, which when executed by said one or more hardware processors, cause:
in response to receiving the request to update the particular document:
inserting the new updated document in a new row of the one or more tables of the DBMS having a new row identifier, and
generating a new document identifier corresponding to the new updated document;
updating the doc-to-row mapping store to add a new row indicating association of the new document identifier with the new row identifier for the new updated document.

18. The one or more non-transitory computer-readable media of claim 13, wherein the set of instructions further includes instructions, which when executed by said one or more hardware processors, cause:
storing, in the index store, value-to-doc mapping comprising of plurality of bitmaps, wherein, for a unique node value, a corresponding bitmap is stored, each bit in the bitmap, of the plurality of bitmaps, representing a unique document of the plurality of documents in which the unique node value is present;
evaluating the first query, the first query comprising a filtering criteria on node values;
determining a result set of node values that match the filtering criteria and selecting a result set of bitmaps corresponding to the result set of node values;
performing a bitwise operation corresponding to the filtering criteria on the result set of bitmaps, thereby, generating a resulting bitmap;
evaluating the first query using resulting one or more documents of the plurality of documents corresponding to one or more bits of the resulting bitmap.

19. The one or more non-transitory computer-readable media of claim 13, wherein the set of instructions further includes instructions, which when executed by said one or more hardware processors, cause:
scanning the plurality of rows in the one or more tables of the DBMS;
identifying a first section root node of a first section of nodes of the one or more sections of nodes, wherein the first section root node is associated with a first section path;
identifying one or more first leaf nodes of the first section root node, corresponding to one or more first leaf paths;
indexing, into the index store, the first section path to the first section root node and the one or more first leaf paths to corresponding one or more leaf node values.

20. The one or more non-transitory computer-readable media of claim 13, wherein the set of instructions further includes instructions, which when executed by said one or more hardware processors, cause:
scanning the plurality of rows in the one or more tables of the DBMS;
identifying a second section root node of a second section of nodes of the one or more sections of nodes, wherein the second section root node is associated with a second section path;
based at least in part on index configuration data, determining whether the second section path a) is included in an exclusion index list of paths, or b) is not included in an inclusion index list of paths;
based, at least in part, on determining whether the second section path a) is included in an exclusion index list of paths, or b) is not included in an inclusion index list of paths, exclude the second section root node and hierarchy of the second section root node from indexing.
